(19) United States
(12) Patent Application Publication
(10) Pub. No.: US 2024/0054510 A1
(43) Pub. Date: Feb. 15, 2024

(54) INTENTION ECONOMY MANAGEMENT SYSTEM

(71) Applicant: Blue Morpho AI LLC, Seattle, WA (US)

(72) Inventors: Maria Solandros Eitel, Seattle, WA (US); Elizabeth Jasperson Flynn, Ridgefield, WA (US)

(21) Appl. No.: 18/231,612

(22) Filed: Aug. 8, 2023

Related U.S. Application Data
(60) Provisional application No. 63/396,413, filed on Aug. 9, 2022.
(60) Provisional application No. 63/472,178, filed on Jun. 9, 2023.

(51) Int. Cl. G06Q 30/0203; H04L 67/306

(52) U.S. Cl. CPC G06Q 30/0203; H04L 67/306; G06Q 2220/00

(57) ABSTRACT

Methods, systems, and apparatus for identifying, for a user profile, a multidimensional set of objectives; configuring a collection system to receive data for the user profile; generating a model and identifying a position within the model for the user profile relative to the multidimensional set of objectives; configuring the collection system to generate, based on the data for the user profile, updates to the position; and generating, for at least a first dimension in the multidimensional set of objectives, a report indicating a first user state relative to a first objective in the multidimensional set of objectives.

### BACKGROUND

Oftentimes individuals choose to prioritize their time in areas that do not fulfill the aspirations that they truly wish to achieve throughout their life. This can be due to the overwhelming amount of advertising people experience on a daily basis, being fed content based on perceived preferences and instant reward, being ignorant of what activities contribute to aspiration fulfillment, distraction by non-goal oriented tasks, or a variety of other reasons.

It would be beneficial to a consumer if the devices they use most frequently take an active role in assisting them in progressing towards their ideal, aspirational life. Establishing a system that is embodied in their technology vs. real human interaction that assists with aspiration achievement, without substantial monitoring or coaching, would allow users to live in a way that is more personally fulfilling, and give them a higher chance of achieving their best life. Technology would support their aspirations and goals, rather than distract them.

### SUMMARY

This specification describes an Intention Economy Management System, also referred to as meKey. Living with intention can be used to describe acting and thinking in a manner that is personally fulfilling and congruent with one's life goals or aspirations. This system determines the user's intentions, identifies barriers to realizing their goal, and then assists the user to act in a way that can help them best achieve and live their ideal life.

A user's intentions can take various forms. For example, “intentions” can be used to describe a person's ideal envisioning of themselves. This envisioning generally includes several large aspirations or goals a person wishes to achieve throughout their life. Example ‘domains’ of these life aspirations and goals can include career development, financial security, achieving a certain social status or standing, improvement in physical health and fitness, mental and emotional wellness, family, friends and romantic relationships, hobbies, and many other aspirations. In some examples, “intentions,” can (and often do) include a multitude of aspirations or goals spread across different life domains.

To live with intention, to progress towards one's domain aspirations, users must undertake certain actions, or refrain from certain other actions. In some examples, a user may not be aware of what actions support or hinder their life aspirations. While methods of algorithm manipulation (advertising, news feeds, search engine results, social media alerts, video recommendations, reading lists, connected home devices, automated customer service agents, applications, etc.) help users become aware of products and services that they desire, this is often done in a vacuum. Additionally, this places the burden on the user to separate what products and services contribute to their aspirations, and which are just spontaneous desire. Further still, algorithm manipulation is conducted without regard to whether the user will benefit from the service or product being marketed or presented. One of the goals of the techniques described below is to actively recommend and reinforce positive actions, and to filter and prioritize content to assist users in achieving their life domain goals and aspirations.

To identify an intention gap between one's intentions and their actions (or inaction), the meKey system first ascertains what life domain aspirations the user possesses. In some embodiments, this solicitation can take the form of a series of questions or a survey to be completed by the user, or it can be questions interspersed and integrated into their interaction with their media. This survey can include questions regarding what life domains the user values, what specific aspirations they wish to achieve, and what barriers they see as impeding them to their aspirations. Other embodiments may ask more, or less questions in different sequencing or forms, to ascertain a user's life domain aspirations.

To determine whether a user is progressing towards their ideal life, the meKey system draws on various forms of data that can be used to make a conclusion. Examples of this data include, location data, transactional data, physiological data, image data, audio data, or various other data that could reasonably be obtained by a user device. Examples of data collection methods include location data obtained through a device's Global Positioning System (GPS) receiver, transactional data obtained from a user's banking application, physiological data obtained through an accelerometer, and image data obtained through a device camera. This list is not exhaustive, and there are many ways of achieving the same measurement through alternative means.

After a certain amount of data collection has occurred, a user may wish to view their progress towards life domain aspirations or goals. Upon receiving a request from the user, or at predetermined intervals, or even constantly in real time, the meKey system can output reports showing life domain status. These reports can be referred to as “intention gaps” or “intention gap reports.” An intention gap report, or intention gap, quantifies a user's divergence from their indicated life domain aspirations.

The meKey system also evaluates the impact of actions on more than one life domain. In some examples, this evaluation is continuous, to include real-time monitoring of actions and interactions across all of a user's life domains. In some instances, the system will attempt to optimize the best possible combination of lifestyle choices for a user with respect to their prioritized life domains.

In general, innovative aspects of the subject matter described in this specification can be implemented in a method, the method including: identifying, for a user profile, a multidimensional set of objectives; configuring a collection system to receive data for the user profile; generating a model and identifying a position within the model for the user profile relative to the multidimensional set of objectives; configuring the collection system to generate, based on the data for the user profile, updates to the position; and generating, for at least a first dimension in the multidimensional set of objectives, a report indicating a first user state relative to a first objective in the multidimensional set of objectives.

Other implementations include a method, the method including: identifying, for a user profile, a multidimensional set of objectives; configuring a collection system to receive data for the user profile; generating a model and identifying a position within the model for the user profile relative to the multidimensional set of objectives; providing the model as a prompt to an analytical engine configured to make recommendations based on received prompts; and, receiving at least one recommendation from the analytical engine based on the prompt.

Other implementations include a method, the method including: identifying, for a user profile, a multidimensional set of objectives; configuring a collection system to receive data for the user profile; generating a model and identifying a position within the model for the user profile relative to the multidimensional set of objectives; storing the model on a blockchain distributed ledger; receiving, from a third-party service, a request to access data corresponding to the model on the blockchain distributed ledger; determining that the third-party service is authorized to access data corresponding to the model; and, in response, transmitting data to the third-party service corresponding to the model.

The foregoing and other implementations can each optionally include one or more of the following features, alone or in combination.

In some examples, the method includes: generating a recommendation for the user profile to move the first user state closer to the objectives in the multidimensional set of objectives.

In some examples, the collection system receives data from at least one third-party service that collects user data.

In some examples, a smart contract authorizes the third-party service to transmit user data to the collection system.

In some examples, identifying a multidimensional set of objectives includes receiving user input to a survey directed to life aspirations.

In some examples, the method includes: determining, by the data collection system and based on data received from the third-party service, that the position of the user profile within the model has changed; and, updating the position of the user within the model.

In some examples, the method includes: based at least in part on updates to the user position, transmitting information that describes the change in user position to at least one third-party service.

In some examples, the method includes: storing data describing the user profile or model on a blockchain distributed ledger.

In some examples, updates to the position in the model also update the data stored on the blockchain distributed ledger.

In some examples, the method includes: transmitting model data from the blockchain distributed ledger using an Application Programming Interface configured to provision model data to at least one third-party service.

In some examples, the analytical engine includes an artificial intelligence service.

In some examples, the analytical engine includes a machine learning algorithm trained on past recommendations.

In some examples, the method includes: updating the multidimensional set of objectives based at least in part on the at least one recommendation.

In some examples, the method includes: receiving updated data, based at least in part on the at least one recommendation; and, updating the position of the user within the model.

In some examples, the method includes: storing data describing the user profile or model on a blockchain distributed ledger.

In some examples, determining that the third-party service is authorized to access the data includes determining that a smart contract allowing data access has been issued to the third party.

In some examples, the smart contract specifies a period within which the third-party service can access data from the model.

In some examples, the request to access data from the model is received from a third-party service Application Programming Interface configured to receive model data.

Particular embodiments of the subject matter described in this specification can be implemented so as to realize one or more of the following advantages. The techniques of this specification actively recommend and reinforce positive actions in a way that simple advertising cannot. In this way, the user can be guided to the goods and services that actually have a positive impact on their life, rather than what may be desired spontaneously. Additionally, the user now has control over how their data is utilized, ensuring user privacy and data sovereignty. Additionally, the prompts generated by these techniques can be used improve the operation of other services, for example, analytical engines such as Artificial Intelligence and machine learning algorithms that make recommendations. Additionally, the techniques of this system allow the user's data to follow them as they navigate different services and applications. Finally, the use of a distributed ledger ensures that data can be continuously updated from various sources while ensuring data security.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is an overview of an example Intention Economy process.

FIG. 1B is an overview of an example prompt of an Intention Economy system.

FIG. 1C is an example user device operating within an example Intention Economy system.

FIG. 2A is an overview of a first example of an Intention Economy system.

FIG. 2B is a detailed view of a first example of an Intention Economy system.

FIG. 2C is a detailed view of a first example of an Intention Economy system implemented in a Web 2.0 environment.

FIG. 2D is a detailed view of a first example of an Intention Economy system implemented in a Web 3.0 environment.

FIG. 3A is an overview of a second example of an Intention Economy system.

FIG. 3B is a detailed view of a second example of an Intention Economy system.

FIG. 3C is an example process for incorporating open AI with a second example of an Intention Economy system.

FIG. 4 is a detailed view of an example user device.

FIG. 5A is an example Intention Economy management system dashboard.

FIG. 5B is an example overview of a focus area in the Intention Economy management system.

FIG. 5C is an example interface for editing a focus area.

FIG. 5D is an example interface for adding a new focus area.

FIG. 6 is an example process where the user generates an intention gap report.

FIG. 7 is an example process for an Intention Economy management system.

### DETAILED DESCRIPTION

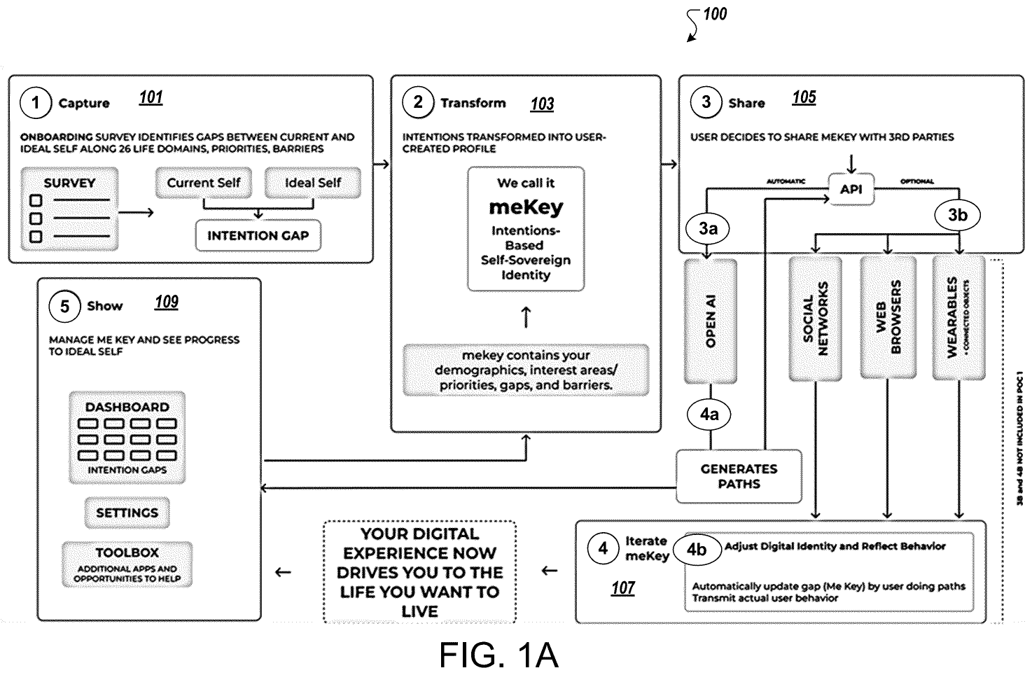

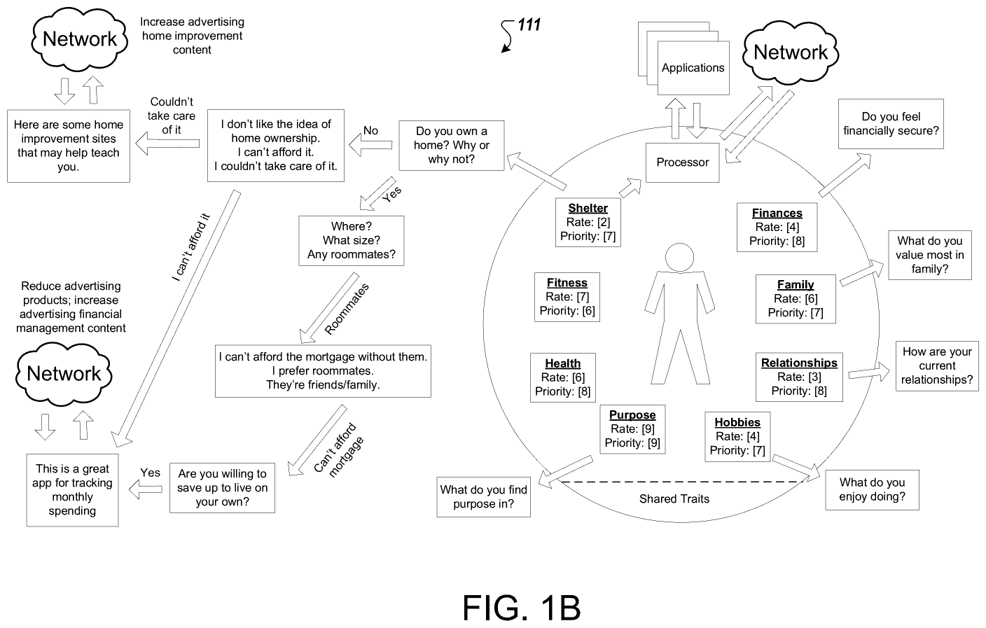

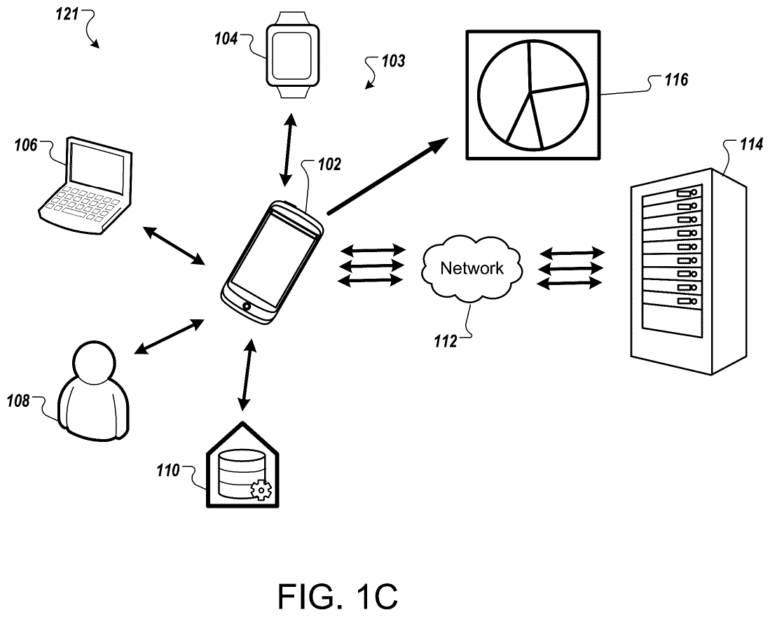

FIG. 1A is an overview 100 of an example Intention Economy process. The example process includes capturing user intentions in step 1 (101), transforming user intentions into a user profile in step 2 (103), sharing the user profile with third parties in step 3 (105), iterating the meKey profile with user behavior in step 4 (107), and displaying the meKey profile to the user in step 5 (109). It should be noted that portions of this process 100 occur in an ongoing manner, and multiple steps can be performed simultaneously in place (e.g., a user can share their meKey with one third party while iterating with another).

In some examples, capturing user intentions 101 is accomplished with the help of a survey. This survey asks the user a series of questions which can include, for example, what they see as their ideal life, where they are currently with respect to this life, and barriers that are preventing them from obtaining that life. In some examples, the survey is administered using an application (e.g., the “meKey” application) that a user has downloaded to a personal device.

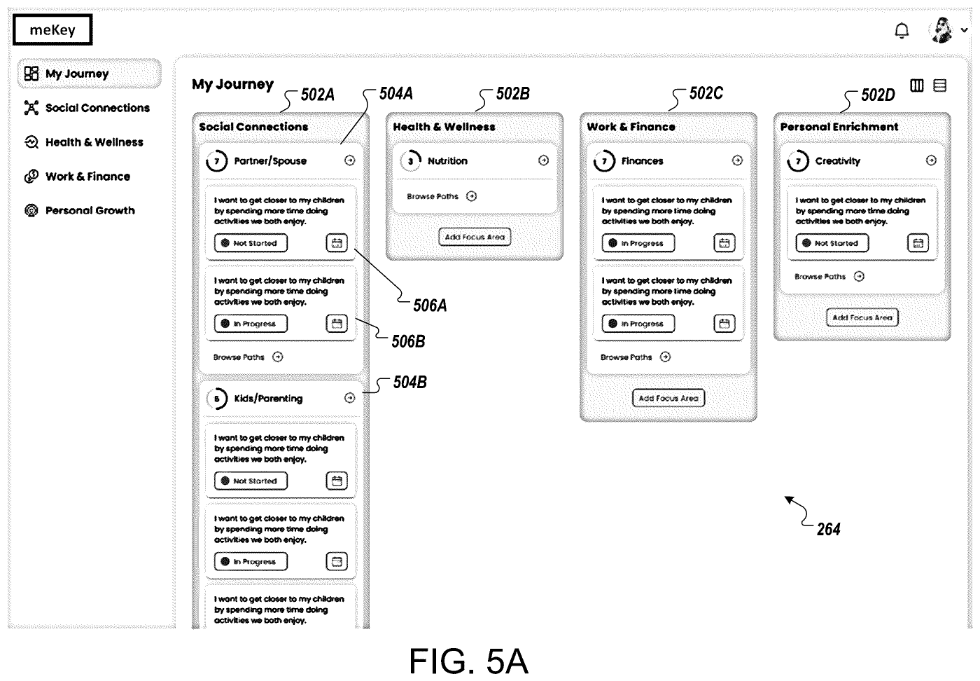

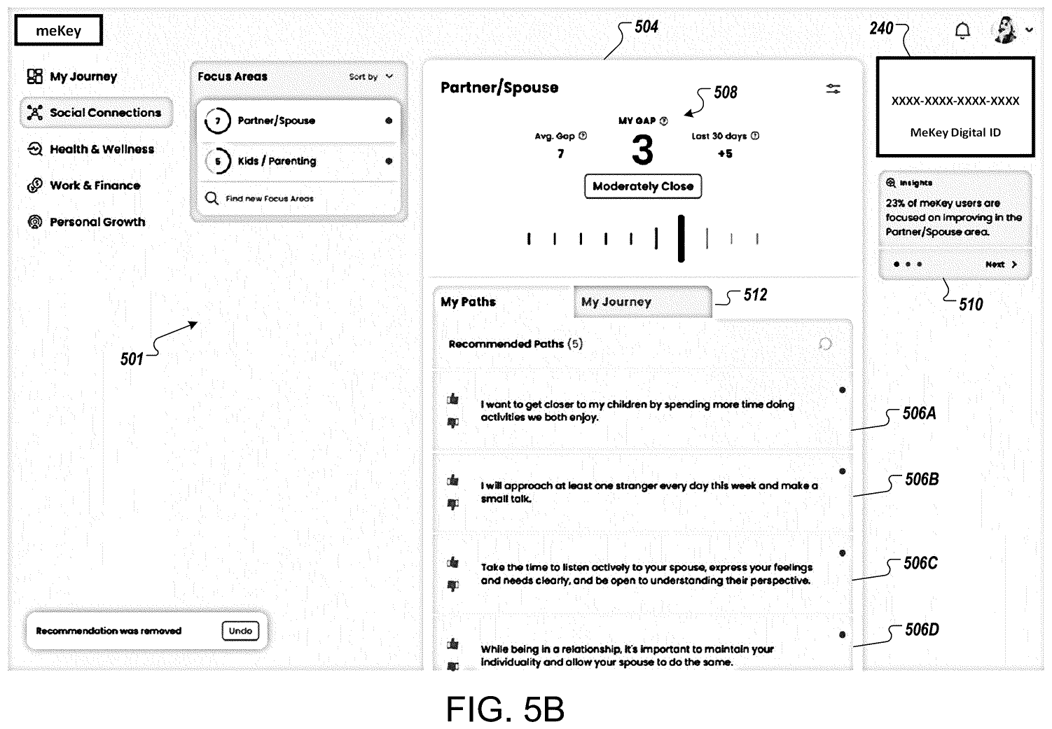

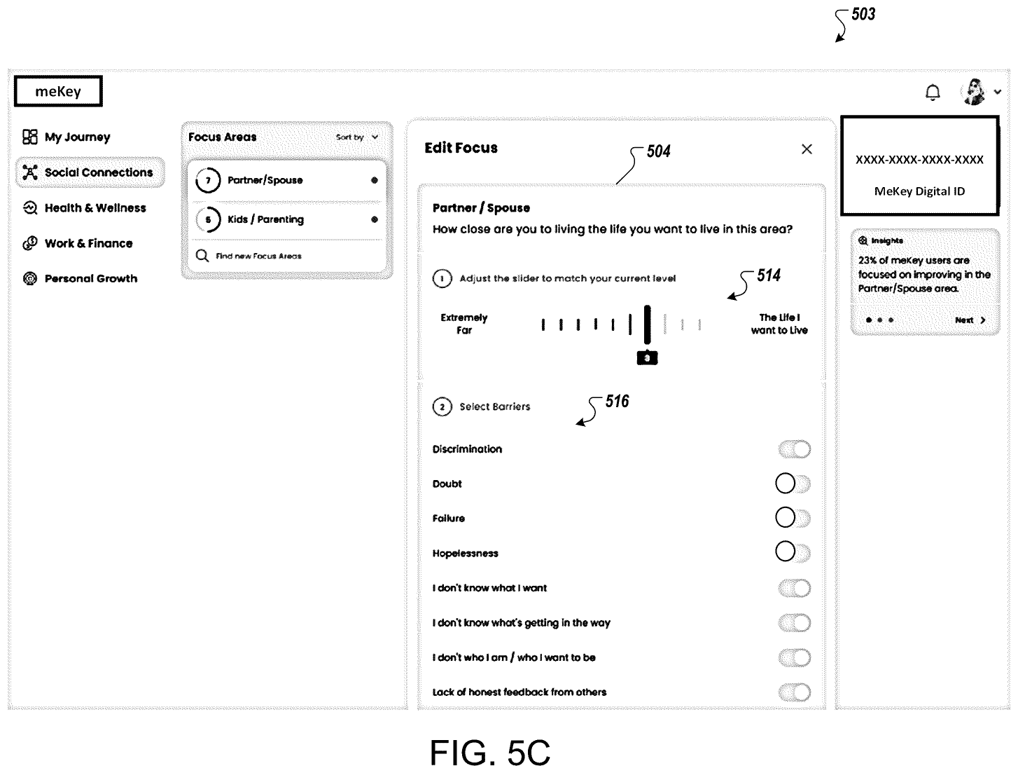

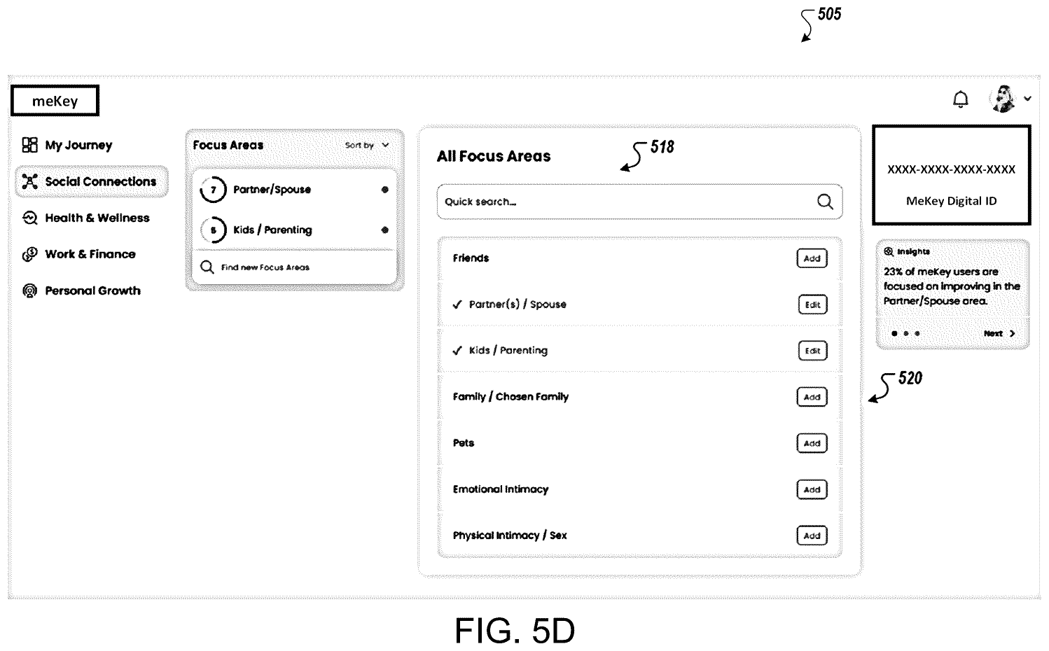

After capturing user intentions, the intentions are then transformed into a user profile 103. In some examples, this user profile is referred to as a “meKey.” meKey, in addition to serving as a user profile, also provides an application for the user to interact with this user profile. In some examples, this application has a dashboard (e.g., a “meKey dashboard”) that allows the user to interact with their transformed intentions. The meKey dashboard is explained in greater detail in the description of FIGS. 5A-5D.

When transforming user intentions 103, the intentions are distilled into a multidimensional set of objectives across multiple areas referred to as “life domains.” Life domains are major areas of one's life, for example, health and wellness, social connection, work and finance, and personal growth and development, to name a few. Each life domain can be further decomposed into smaller “focus areas” that contribute to the overall domain. For example, a “social connection” life domain can be further decomposed into focus areas for a user's “partner or spouse” and “children and parenting.” Focus areas can be used to provide discrete feedback to the user and provide the basis for “paths” to progress the life domain as a whole. “Paths” are actionable improvement plans that contribute to progressing a focus area for a user. For example, a user that has indicated a focus area around parenting can be presented with a path that prompts them to spend a certain amount of time each week doing activities they and their children both enjoy. In addition to paths, focus areas can be associated with “barriers.” Barriers serve as hurdles to progressing a focus area, for example, a busy schedule that prevents the user from dedicating time to spend with their children. Barriers can be designated by the user in advance or become evident as the meKey user model iterates.

Once the above areas have been identified, a model is generated that describes the user's life domains, focus areas, paths, and barriers. In some examples, this model is a meKey Digital Identification (DID) that contains all the necessary data to describe the multidimensional set of objectives that forms the user's meKey profile. In some examples, the user's meKey DID is a blockchain construct that can be stored on a distributed ledger and provided to third parties as needed. Because the meKey DID describes the user's intentions, this data can be used to guide the user as they interact with various forms of social media and online products. For example, while browsing the internet with their meKey DID linked to their browser, the user can be presented with content that is more likely to progress their focus areas and/or paths. In this way, the meKey system is more than just simple advertising. Indeed, while advertising may try to predict what a user wants to see, it does not consider what a user needs to see.

Additionally, meKey DID identifies a user's position with respect to each of their objectives. In some examples, this position is an “intention gap” that quantifies a user's divergence from their indicated life domain aspirations. For example, a scale of “1” (farthest) to “10” (closest) can be used to rank a user's progress in a focus area or life domain. In this example, a score of “3” can be referred to as the user's intention gap. The intention gap is described in greater detail in the description of FIGS. 5A-5D. Additionally, the meKey system continually generates updates to a user's intention gap based on data received by the system. Gap reports can be generated by the system for each of the life domains and focus areas associated with the multidimensional set of objectives associated with the user's profile.

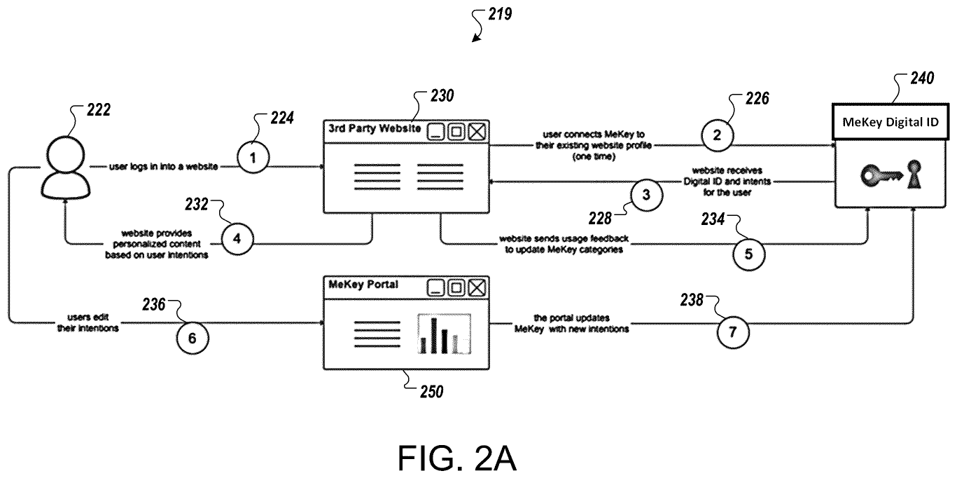

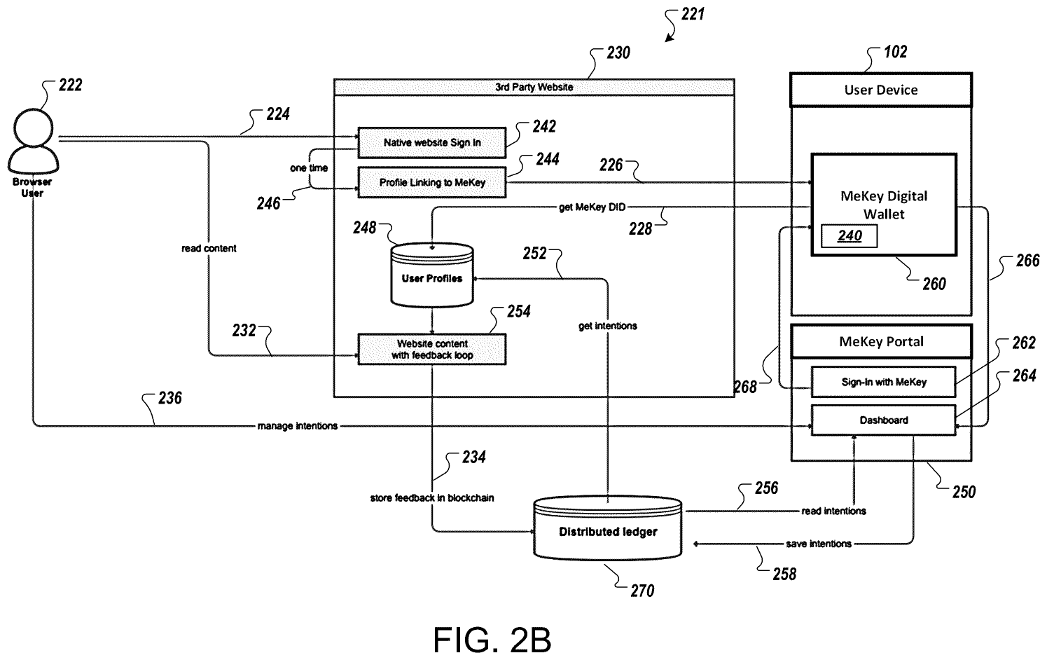

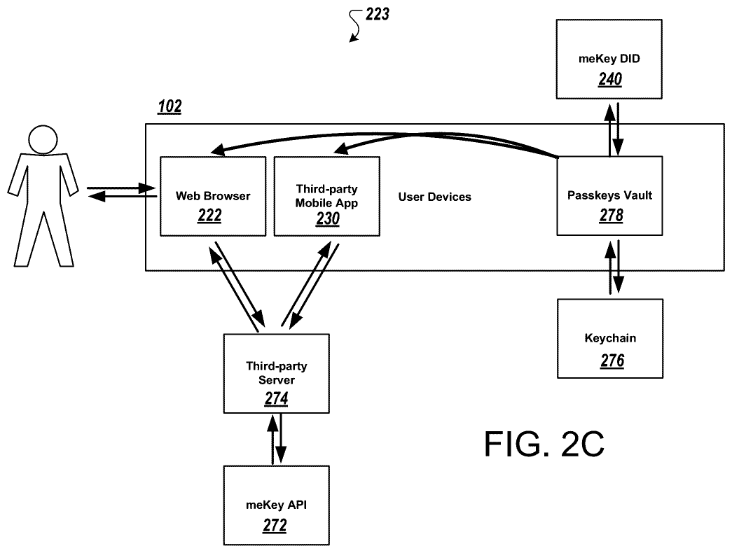

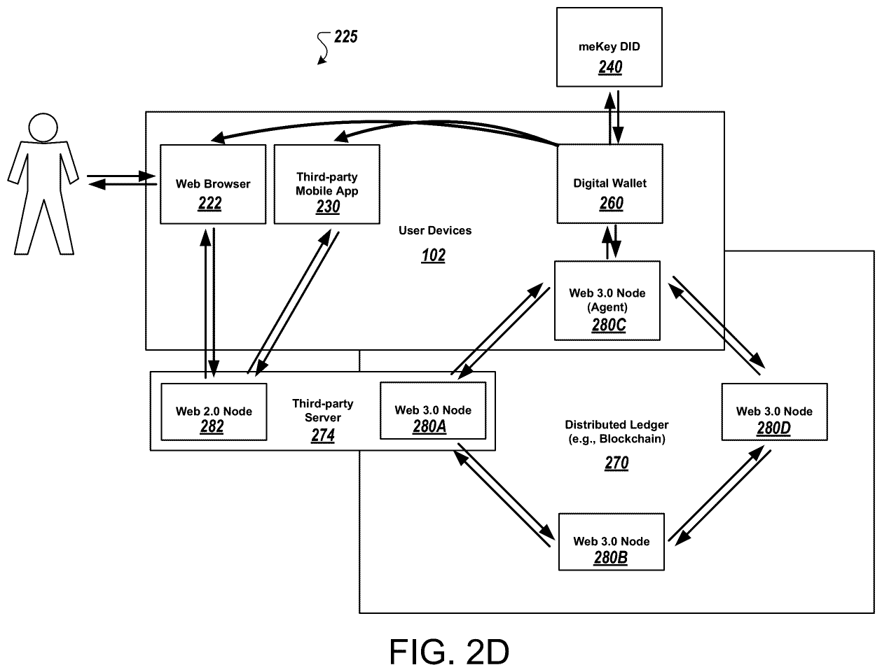

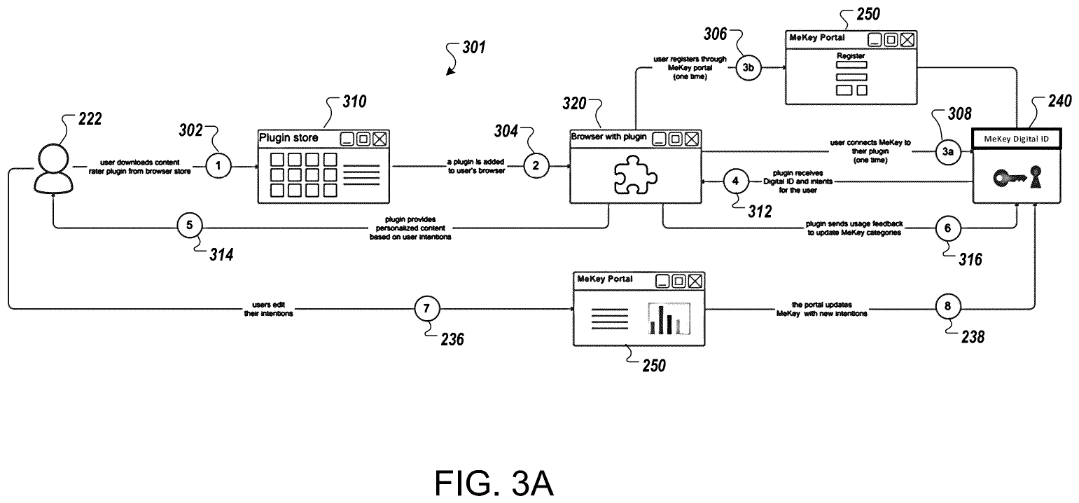

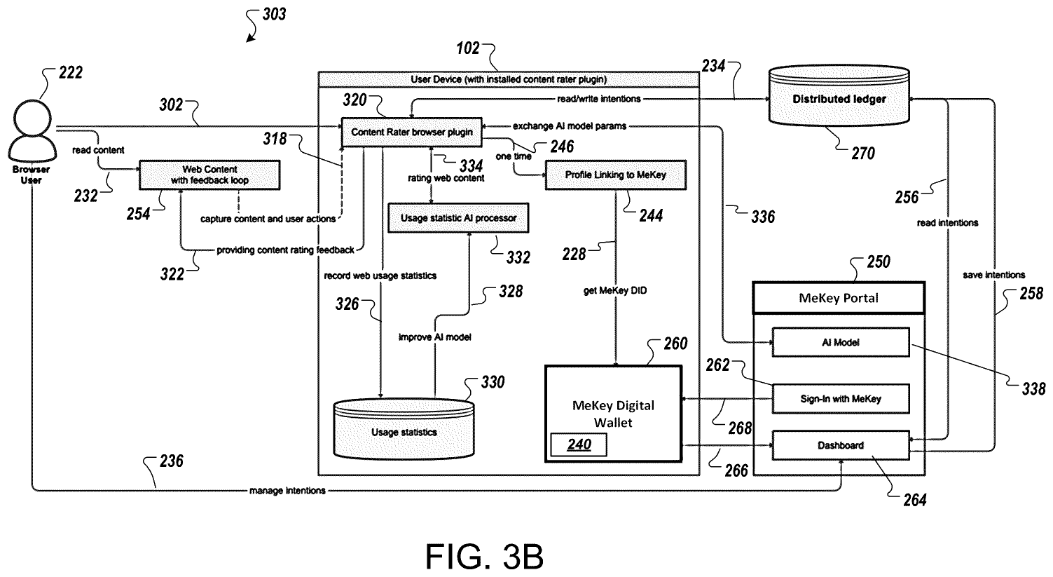

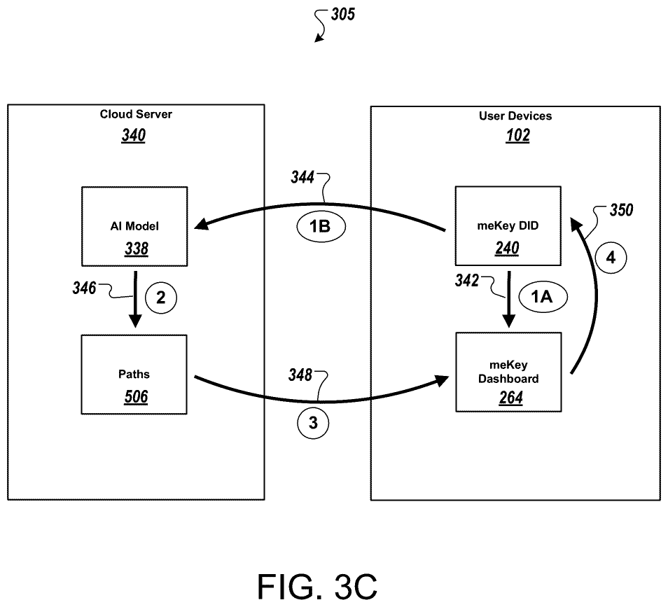

After a user's meKey DID is formulated, this model can then be shared with third parties 105. For example, a user can decide to share their meKey DID with their favorite applications and services so that their data and intentions follow them. In this way, users have control over how their data is used on these platforms and are consciously aware of how their information is being used. In some examples, users can enter smart contracts with third parties that allow access to the user's meKey DID on the blockchain and specify the conditions for this access. meKey can be linked not only to applications and services (3b and 4b), but also Artificial Intelligence services that provide outputs based on prompts (3a and 4a). Detailed examples of this process are described in FIGS. 2 and 3 below. FIG. 1B provides an overview 111 of example prompts of an Intention Economy system.

When a user's meKey DID is linked to other services, the meKey system iterates 104. In some examples, this iteration automatically updates the user's intention gap and set of objectives based on the actions the undertake on the linked services. For example, when browsing the internet, making purchases, or viewing content, the choices made by the user can impact their various focus areas and paths. This information is then provided to their meKey DID so the user's model can be updated accordingly.

In addition to iterating the meKey, the user can also view the progress of their meKey 109. In some examples, this progress is illustrated as an intention gap or gap report for each of the user's life domains and focus areas. In some examples, these reports can be made available on a meKey dashboard. In some examples, a user can also use this meKey dashboard to modify their meKey and objectives, for example, adding a life domain, focus area, or path.

FIG. 1C is an example user device 102 operating within an example Intention Economy system 103. The intention key system 100 includes a user device 102, one or more applications 104, 106, 108, and 110, one or more networks 112, one or more servers 114, and one or more reports 116.

Example user devices 102 include a smartphone, laptop, tablet computer, entertainment system, or various other devices assumed to have sufficient data collection ability. Additionally, a user can have multiple devices that can be considered the “user device 102” (e.g., a laptop and smartphone executing the same application). The user device 102 generally executes a suite of applications. Examples of these applications include a fitness application 104, medical application 106, social media application 108, or banking application 110. Other applications running on the user device 102 not listed above may be included in the system 103, for example, applications that are provided by a service provider, a service plan, or those that are downloaded from an application store.

This user device is in communication with network 112. In some examples, network 112 is a wireless network (e.g., a WWAN or WLAN), a cellular network (e.g., 4/5G), or an Internet connection. Through the network 112, the user device 102 is in communication with servers 114 that control various operating features or applications on the user device 102. For example, the server 114 can store operating instructions for the social media application 108 and communicate these to the user device 102 through the network 112.

The system 103 can also output one or more reports 116 to the user device 102 or to the server 114 through the network 112. This report 116 contains various operating metrics obtained through the applications running on the user device 102. In some examples, this information can also be stored on the server 114.

FIG. 2A is an overview 219 of a first example of an Intention Economy management system. The first example includes a user executing a browser or application 222, a third-party website 230, a meKey Digital identification (DID) 240, and a meKey portal 250. Additionally, an example process is presented with the first example system.

In an example process, the user 222 logs into a third-party website 230 using a browser in step 1 (224). The user wishes to allow the website 230 to access the data in their meKey DID 240 to improve their experience, so they authorize the website 230 to access their meKey DID 240 for “one-time” use in step 2 (226). While one-time use is shown in this process, other examples can use different contract terms. For example, the user can enter a smart contract with the third-party website 230 that allows the website 230 to access the user's meKey DID 240 for a period of time in exchange for compensation or incentives for the user. After receiving authorization, to access the meKey DID 240, the website 230 receives the data in step 3 (228). In some examples, this data can be active life domains, focus areas, or paths for the user. Other examples of data can include metrics collected for any of the above areas, or information the user has stored in their meKey DID 240.

After receiving the data from the meKey DID 240, the website 230 then provides content to the user 222 based on the data from their meKey DID 240 in step 4 (232). In some examples, using data from the user's 222 interactions with the content, the website 230 can send feedback to update features of the meKey DID 240 in step 5 (234). For example, if the user 222 performs an action on the website 230 that completes an action in a path, the website 230 can send an indication to the meKey DID 240 that the corresponding path has made progress.

In some examples, the user 222 can also update their intentions in the meKey portal 250 in step 6 (236). For example, the user 222 can add a focus area or path to a life domain, modify the importance of a focus area, or remove a focus area or path. When receiving an update from the user 222, the meKey portal 250 updates the information in the user's meKey DID 240 in step 7 (238).

FIG. 2B is a detailed view 221 of a first example of an Intention Economy system. The example detail view 221 includes a user device 102, a user executing a browser or application 222, a third-party website 230, a meKey DID 240, a meKey portal 250, a meKey digital wallet 260, and a distributed ledger 270. Additionally, an example process is presented with the first example system. While the user 222 and user device 102 are illustrated separately, it should be noted that the user 222 can be executing the browser or application on user device 102.

In some examples, when signing into a third-party website 230 in step 224 the user accesses a login portal 242 that allows one-time access 246 to a website profile 244 that interfaces with the meKey DID 240. After receiving a successful login, the profile 244 requests updated meKey DID 240 data from the user's digital wallet 260. The requested data is then imported from the meKey DID 240 into a database of user profiles 248 corresponding to the third-party website. In some examples, these profiles can be stored on a server that hosts the website 230 (not pictured). Using this data, the website 230 serves content 232 to the user in a feedback loop 254. Additionally, the meKey DID 240 can make content 232 recommendations directly to the website 230 designed to progress the user towards their meKey objectives. For example, the meKey DID 240 can direct the website 230 to surface content that recommends to a user with a social connection goal to attend a social function where they are likely to meet new acquaintances. In some examples, the third-party website 230 can execute an API that allows the website 230 to integrate with the meKey DID 240.

In some examples, as the user views and interacts with content, the feedback loop 254 stores feedback data 234 in a distributed ledger 270. In some examples, the distributed ledger 270 is a blockchain structure that executes on a combination of devices, to include servers associated with the website 230, the user device 102, or independent servers (not pictured). In some examples, the distributed ledger 270 is also in communication with the user's meKey portal 250 and can request 256 and update 258 user intentions modified 236 through the meKey portal 250. The distributed ledger 270 can then update 252 the user's profile 248 on the third-party website 230.

In some examples, the meKey portal 250 is in constant communication with the user's meKey digital wallet 260 and meKey DID 240. For example, when receiving an update 236 to intentions from the user 222, the meKey portal 250 can update 268 the user's meKey DID 240. In some examples, the meKey portal 250 allows the user to log in to the portal 262 using their meKey DID 240 credentials. Additionally, in some examples, the meKey portal 250 also includes a dashboard 264 that displays information to the user 222 regarding their intentions. The dashboard 264 can additionally receive updates to the user's intentions from the user's meKey digital wallet 260 (step 266) and/or the distributed ledger 270 (step 256).

FIG. 2C is a detailed view 223 of a first example of an Intention Economy system implemented in a Web 2.0 environment. The example detailed view 223 includes a user device 102, meKey DID 240, third party server 274, keychain 276, and meKey Application Programming Interface (API) 272. Additionally, the user device 102 in this example is executing a web browser 222, third-party application 230, and passkeys vault 278.

In some examples, to ensure operability with legacy Web 2.0 websites, the Intention Economy management system includes components that allow legacy websites and applications to integrate with the meKey DID 240. For example, the user device 102 can include a passkeys vault 278 that stores various credentials. These credentials include a meKey DID 240 as well as other keychains 276 (e.g., keys for other products such as iCloud or Google Drive). When accessing a third-party application 230, either directly or through browser 222, the third-party server 274 can verify and access the user's meKey DID 240 through a meKey API 272 designed to integrate with the website's architecture. For example, the meKey API 272 can map metrics and instructions in the meKey DID 240 to existing fields in the third-party application 230. In this way, even if a legacy Web 2.0 application or website is not designed to directly integrate with a distributed application (such as the Intention Economy management system) the user can still realize the benefits of the meKey DID 240 to the maximum extent the website or application 230 allows.

FIG. 2D is a detailed view 225 of a first example of an Intention Economy system implemented in a Web 3.0 environment. The example detailed view 225 includes a user device 102, third-party servers 274, a distributed ledger 270 with multiple Web 3.0 nodes 280, and a meKey DID 240. Additionally, the user device 102 in this example is executing a web browser 222, third-party application 230, digital wallet 260, and a Web 3.0 agent node 280C.

In contrast to a Web 2.0 architecture, Web 3.0 allows data to be distributed in a blockchain or distributed ledger 270 of multiple nodes 280. In some examples, meKey 240 data can be shared between these nodes 280 and referenced by different parties when allowed. For example, if a user has authorized a third-party server 274 to access their meKey 240 via a smart contract, the server 274 can be allowed access to the nodes 280B, 280C, and 280D that contain the requested data. In some examples, a third-party server 274 can then utilize this data in a Web 2.0 node 282 in communication with an application 230 or browser 222 executing on the user's mobile device 102. In some examples, the third-party server 274, web browser 222, or third-party application 230 can execute an API that allows each of these services to integrate with the meKey DID 240.

For example, a user browsing a merchant's website can enter a smart contract with the merchant that allows the merchant access to the user's meKey DID 240. Using the paths data in the meKey DID 240, the merchant's server 274 can manipulate a content serving algorithm that presents content to the user that is more in line with their paths. In some examples, the agent node 208C on the user device can access the meKey DID 240 through a digital wallet 260 on the user device 102 and provide the paths data to other nodes 280 on the distributed ledger 270.

FIG. 3A is an overview 301 of a second example Intention Economy system. The second example system includes a user executing a browser or application 222, a meKey DID 240, a meKey portal 250, a plugin store 310, and a browser with an installed plugin 320. Additionally, an example process is presented with the second example system.

In contrast with the first example, the second example Intention Economy management system includes a browser plugin 320 that allows the meKey DID 240 to interface with prompt-driven products, such as Artificial Intelligence (AI) models (e.g., OpenAI GPT, Google Bard, etc.) and other analytical engines. While the plugin is described primarily with respect to these products, it should be noted that the plugin 320 can be designed to allow the meKey DID 240 to be compatible with other products. For example, the plugin 320 can interface with a machine learning model trained on past recommendations or content served to users.

To install the plugin 320 on a browser, the user 222 first downloads the plugin from a plugin store 310 in step 1 (302), after which the plugin is added to the user's browser in step 2 (304). After the plugin is installed, the user has various options on how to integrate the meKey DID 240 content with their browser 320. In one example, the user connects their browser 320 directly to their meKey DID 240 for one-time access in step 3a (308). In another example, the user registers their browser 320 through the meKey portal 250 for one-time access in step 3b (306).

After the browser 320 has been allowed access to the meKey DID 240, the browser plugin 320 receives data from the meKey in step 4 (312). The browser plugin 320 then provides personalized content to the user 222 in step 5 (314). In some examples, the plugin 320 additionally sends usage feedback to the meKey DID 240 in step 6 (316).

In some examples, the user 222 can also update their intentions in the meKey portal 250 in step 7 (236). For example, the user 222 can add a focus area or path to a life domain, modify the importance of a focus area, or remove a focus area or path. When receiving an update from the user 222, the meKey portal 250 updates the information in the user's meKey DID 240 in step 8 (238).

FIG. 3B is a detailed view of a second example of an Intention Economy system. The second example system includes a user device 102, a meKey DID 240, a meKey portal 250, a meKey digital wallet 260, a distributed ledger 270, a browser with an installed plugin 320, and usage statistics 330. Additionally, an example process is presented with the second example system. While the user 222 and user device 102 are illustrated separately, it should be noted that the user 222 can be executing the browser or application on user device 102.

In some examples, after downloading the plugin to a browser 302, the plugin 320 receives data from a profile via one-time access 246 to profile 244 that links 228 to the user's meKey digital wallet 260 and meKey DID 240. While one-time access is illustrated in this example, other examples can utilize other access conditions, for example, a smart contract that specifies a period within which the browser plugin 320 can access the meKey DID 240 and/or meKey digital wallet 260.

In some examples, after receiving data from the user's meKey DID 240, the plugin 320 begins to serve content 232 in a feedback loop 254. This feedback loop 254 provides data relating to a user's 222 interaction with served content 232, which is then provided 326 to a database of usage statistics 330. In some examples, these usage statistics 330 are used to improve 328 an Artificial Intelligence (AI) processor 332 that rates content 334 and controls how the plugin 320 recommends content to be served 232. While illustrated as part of the user device 102, the AI processor 332 can be executing on different devices within the system, for example, an external server in communication with the user device 102 over a network (not pictured). Alternatively, or in addition, the plugin can also receive feedback regarding its content ratings 322.

In some examples, to further refine the AI processor 332 and/or plugin 320, the plugin 320 receives parameters 336 from an AI model 338 executing in the meKey portal 250. In some examples, this AI model 338 accepts portions of the user's meKey DID 240 as a prompt to generate additional data predicting content that is most relevant to the intentions described by the user's meKey DID 240. While the AI model 338 is shown as executing within the meKey portal 250 in this example, in other examples the AI model 338 can be located in other devices in the system, for example, a server in communication with the meKey portal 250 over a network (not pictured). Additionally, the meKey DID 240 can make content 232 recommendations directly to the plugin 320 designed to progress the user towards their meKey objectives, in a manner similar to what was described for FIG. 2B.

In some examples, as described above in the first example system, the feedback loop 254, using plugin 320, stores feedback data 234 in a distributed ledger 270. In some examples, the distributed ledger 270 is a blockchain structure that executes on a combination of devices, to include servers associated with the website 230, the user device 102, or independent servers (not pictured). In some examples, the distributed ledger 270 is also in communication with the user's meKey portal 250 and can request 256 and update 258 user intentions modified 236 through the meKey portal 250.

In some examples, as described above in the first example system, the meKey portal 250 is in constant communication with the user's meKey digital wallet 260 and meKey DID 240. For example, when receiving an update 236 to intentions from the user 222, the meKey portal 250 can update 268 the user's meKey DID 240. In some examples, the meKey portal 250 allows the user to log in to the portal 262 using their meKey DID 240 credentials. Additionally, in some examples, the meKey portal 250 also includes a dashboard 264 that displays information to the user 222 regarding their intentions. The dashboard 264 can additionally receive updates to the user's intentions from the user's meKey digital wallet 260 (step 266) and/or the distributed ledger 270 (step 256).

FIG. 3C is an example process 305 for incorporating open AI with a second embodiment of an Intention Economy system. The example process includes a meKey DID 240 and a meKey dashboard executing on a user device 102, and an AI model 338 executing on a cloud server 340. While the example process includes an AI model 338, any analytical engine capable of parsing data relating to user intentions can be used (e.g., a trained machine learning algorithm).

As described in the above examples, the meKey DID 240 is in communication with a meKey dashboard 264 (illustrated as step 1a (342)). Additionally, the meKey DID 240 can export data as a prompt to an analytical engine, for example, AI model 338 (illustrated as step 1b (344)). In some examples, the user's initial intention survey can be used as a prompt to feed the AI model 338 data regarding the user's intentions, to include their life domains, selected focus areas, and any existing paths. With this information, when the AI model 338 receives subsequent prompts from the meKey DID 240 or user, the model 338 can tailor its responses based on the initial understanding of the user's intentions. In some examples, AI model 338 is seamlessly connected to the meKey DID 240 or meKey dashboard 264, such that user requests or actions received through these interfaces are processed in the background by the AI model 338 on cloud server 340.

In some examples, after receiving a prompt, the AI model 338 can generate a new path 506 for a user in step 2 (346). Alternatively, the AI model 338 can also modify an existing path 506 for a user. For example, an AI model 338 can be asked by a user to propose a recommendation for a weekend vacation. Using a previously provided prompt, the AI model can determine that a user has an active path to spend more time with their children. In response to this prompt, the AI model 338 can present the user with vacation destinations that a child would likely enjoy. If the user subsequently selects the vacation destination, the user's path 506 can be updated accordingly. Once the path 506 has been generated or modified by the AI model 338, it is then provided for display to the user on their meKey dashboard 264 in step 3 (348).

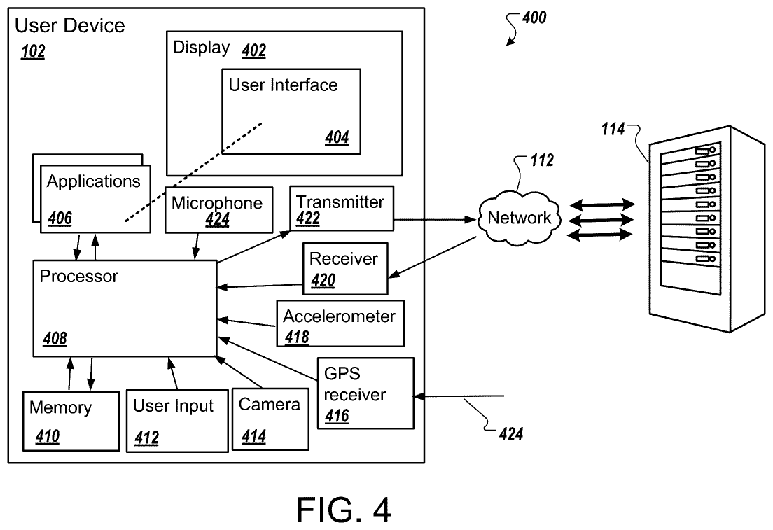

FIG. 4 is a detailed view 400 of an example user device 102. User device 102 contains multiple components for data collection, storage, and processing to include a display 402, user interface 404, applications 406, processor 408, memory 410, various forms of user input 412, camera 414, GPS receiver 416 receiving a signal 424, accelerometer 418, receiver 420, transmitter 422, and microphone 424. One or more of these components can be in communication with servers 114 through network 212.

In some examples, the Intention Economy system is executing on the user device 102 in the form of an application or applications 406. In some examples, data is presented to the user through a user interface 404 on display 402. In some examples, user interface 404 can be configured to accept input through the display 402, for example, a touch detected through a smart phone display.

In some examples, applications 406 are executed by processor, which is operably coupled to memory 408. In other examples, instructions for applications 406 are received from servers 114 over network 112 via receiver 422. The processor 408 can also direct data to be transmitted to servers 114 over network 112 through transmitter 422. Additionally, processor 408 can receive data from various components within the user device 102, for example, audio data from the microphone 424, physiological data from the accelerometer 418, location data from the GPS receiver 416, video data from the camera 414, and haptics from user input 412.

In some examples, the Intention Economy management application 406 (hereafter the “application 406,” or meKey portal 250) accepts data obtained by the processor 408 from various sources. For example, if the application 406 is configured to track the user's progress to a physical fitness aspiration, the application 406 can request physiological data obtained by the accelerometer 418 and processed by the processor 408. In another example, the application 406 can request information from the processor 408 regarding other applications 406 running on the user device 102. For example, if the application 406 is configured to track the user's progress to a financial aspiration, the application 406 can request from the processor 408 information contained within a banking application 406 running on the user device. In another example still, if the application 406 is configured to track the user's progress towards a shelter aspiration, the application 406 can request relevant data from past surveys and questions stored in the device memory 408.

In some examples, data collected by the application 406 can be further processed by the application 406 or configured for display to the user via the user interface 404. This processing can be performed either locally by the device processor 408 or separately over network 112 using servers 114. The application 406 can also direct the processor 408 to store the collected data on servers 114, or to transmit the data via the transmitter 422 to another destination on network 112.

For example, the application 406 can use the device microphone 424 to detect audio from the user after an inquiry is made by the system. Depending on the response of the user, the application 406 can update life domain metrics. In this example, if the application 406 asks the user “how did you sleep?” and receives a response of “not well”, negative points may be assigned to the “sleep” life area contained within the physical fitness life domain.

In addition to the nature of the response, the application 406 can also analyze the tone of the response. In some examples, the application 406 can measure the tone of the response against data contained in another application 406 that has previously collected this biometric data. For example, upon receiving a short answer from the user in response to a question, the application 406 can determine, based on previously collected biometric data, that the user is simply busy by examining their calendar application and noting a full schedule. However, the system can also determine that a short answer could correspond to a lack of engagement on the part of the user if the same calendar application is examined and the user's schedule is empty.

This method of audio processing can additionally utilize other components of the user device 102. For example, the received user audio may be compared to a location received from the GPS receiver 416, or from an image received from the device camera 414. Other input from components may also be used by the application 406 to provide context to the received audio.

In some examples, the nature of audio processing as described above can be a form of Natural Language Processing (NLP). Using this method, the application 406 can provide context to the responses detected from the user to determine if there is any correspondence to a life domain. The results obtained from this method can then be used to update the user's standing in the multidimensional life domain model. In some examples, this determination can be done simultaneously for different life domains. For example, a user response may cause an effect in both the physical fitness and mental and emotional health life domains.

FIG. 5A is an example Intention Economy management system dashboard 264. The example dashboard 264 includes multiple life domains 502, multiple focus areas 504, and multiple paths 506. While a certain organization of these components is presented in the example dashboard 264, the tailoring of the Intention Economy management system to the individual user means that each user's dashboard 264 will be unique and include differing numbers of life domains 502, focus areas 504, and paths 506. While certain example life domains 502, focus areas 504, and paths 506 are illustrated, it should be noted that these examples are non-limiting and additional examples are possible.

In some examples, the dashboard 264 presents a breakdown of each life domain 502 applicable to a user. This breakdown includes all focus areas 504 within the domain 502 that the user has selected or subscribed to. In some examples, additional data for each focus area 504 is displayed within the breakdown. For example, a user's current intention gap or average gap score can be displayed for each focus area 504. In another example, the active paths 506 in a focus area 504 can also be displayed.

In some examples, customization options are presented to the user to modify the appearance of the dashboard 264. For example, the user can be presented with options to add a focus area 504 to a life domain 502, modify the appearance or hide a focus area 504, or expand an existing focus area 504 to see additional data. Additionally, the user can be presented with controls for altering the visual appearance or arrangement of the dashboard 264.

Additionally, the customization options can specify the operation of the Intention Economy management system. For example, the customization options can include a desired frequency to provide gap reports 508, or instructions on the user's preference for notifications. The customization options can also include various ways to change data collection or allow the user to specify what type of data collection is allowed.

FIG. 5B is an example overview 501 of a focus area 504 in the Intention Economy management system. The example overview 501 includes multiple paths 506, a gap report 508, an insight 510, a focus area history 512, and a link to the user's meKey DID 240. Like the dashboard 264, each focus area 504 will be unique to the user and will vary from person to person.

In some examples, when viewing the detailed breakdown of a focus area 504 the user is presented with a list of applicable paths 506. The organization of these paths 506 can vary depending on different factors and can also be customized by the user. For example, a path 506 that has most recently seen progress can be displayed first in the list. Alternatively, or in addition, the user can “like” or “dislike” certain paths 506 to alter their appearance in the list. In some examples, selecting the path 506 allows the user to see the data applicable for that specific path 506.

In some examples, a gap report 508 is displayed for the focus area 504. In general, the gap report 508 displays a user's departure from their indicated ideal life aspirations. In some examples, the gap report 508 is presented to the user through an intuitive manner such as a chart of graph (e.g., a slide bar). While one gap report 508 is shown, multiple gap reports 508 may be displayed in a single report for multiple focus areas 504 or paths 506. These gap reports 508 can be generated at predetermined checkpoints, or in response to certain stimuli.

In some examples, metrics corresponding to the gap report 508 are displayed. For example, the user's average gap can be displayed, or the trend in a user's gap over a specified time (e.g., a month). Additionally, the graph of the gap report 508 can indicate a proximity or distance from a target, for example, three “marks” from a goal as illustrated in the example gap report 508. Alternatively, or in addition, the gap report 508 can also present additional information explaining the gap report to the user 508. In some examples, gap reports 508 are determined from an aggregation of the scoring that has been conducted in response to the various data that has been collected by the meKey DID. Gap reports 508 can also be requested and shared with external parties and devices if certain user permissions are granted. Various information can be gleaned from intention gap reports, and certain tripwires within the reports can cause the user's device, or an external device, to change its operation.

In some examples, the detailed breakdown of the focus area 504 can include an insight 510 that presents additional information to the user. For example, an insight 510 can provide statistical analysis from similar focus areas 504 of multiple other anonymous users. In some examples, the user can be presented with multiple such insights 510.

In some examples, the history 512 of the paths 506 that form the focus area 504 can also be displayed to the user. In some examples, this history 512 is referred to as a “journey.” A journey can display the trend in an intention gap for a focus area 504 or path 506, critical milestones noted by the system, metrics and collected data, or a combination of these features.

FIG. 5C is an example interface 503 for editing a focus area 504. This example interface 503 includes a control 514 for modifying a user's current level in a focus area 504 and a collection of barriers 516 to a focus area 504. Like the dashboard 264, each focus area 504 will be unique to the user and will vary from person to person.

In some examples, a control 214 is provided in the interface 503 that allows the user to change their progress in a focus area 504. In some examples, this control allows the user to specify an initial condition for a newly selected focus area 504. For example, after selecting a “partner/spouse” focus area 504, the user can be asked to specify how close they believe they are to their ideal life with respect to this focus area 504. This initial indication can then be used by the Intention Economy management system when analyzing the particular focus area 504.

In some examples, barriers 516 can be identified either by the user through the interface 503 or recognized by the Intention Economy management system from an ongoing analysis of a focus area 504. In some examples, these barriers can be tracked and incorporated into metric 502 data collection. For example, a user that indicates they only receive four hours of sleep a night will have a negative factor applied to all data collected that pertains to their physical fitness.

FIG. 5D is an example interface 505 for adding a new focus area 504. In some examples, the user is provided with a list 520 of possible focus areas 504 to select. Alternatively, or in addition, the user can also be provided with a search function 518 that can be used to browse focus areas 504 based on specific user input.

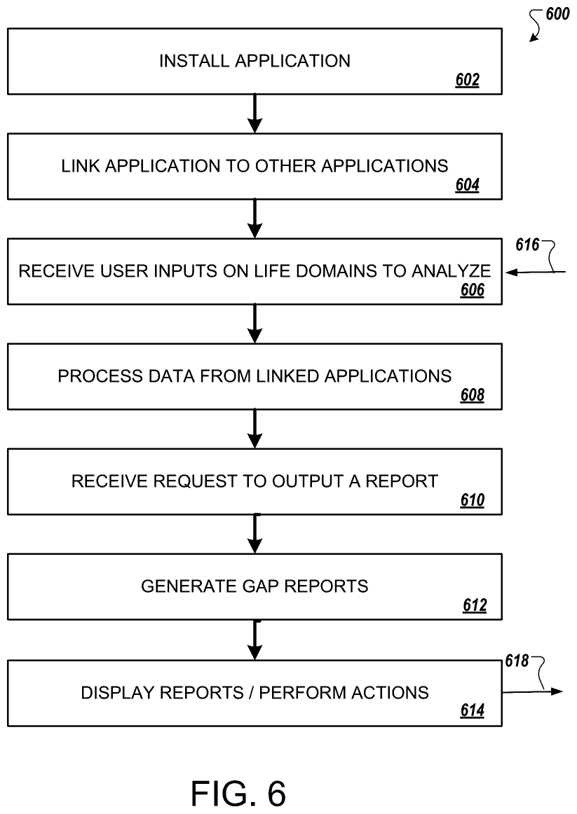

FIG. 6 is an example embodiment of a process 600 in where the user generates an intention gap report. This process may include installing one or more system applications 602, linking the one or more system applications to other applications running on the user device 604, the installed system application then receiving data correlating to one or more specified life domains 606, the system application processing said received data 608, the system application receiving a request to output a report 610, the application generating one or more intention gap reports 612, and the system application displaying these reports 614.

Installation of the system application 602 may be conducted by the user or performed by a third-party device communicating instructions to the user device. Installation may be initiated from different venues, to include application stores available to the user device, or over a network such as the internet.

Linking the system application to other applications 604 running on the device may be completed manually by the user or may be conducted automatically by the system application. In some embodiments, the user may specify which applications the system application is to establish a link with. Other embodiments may call for an external third-party device to communicate this information to the user device and system application. For example, a server may communicate to the system application that, for a user that has indicated a physical fitness life aspiration, the system application must link with a fitness application or a sleep tracking application.

The system application also receives input on which life domains to analyze 606. This input may be provided by the user or other external input 616. In other embodiments, the system application may track a default set of life domains if no input is specified.

The system application then processes received data from the linked applications 608. These linked applications may include fitness applications, medical applications, social media applications, or banking applications. Data retrieved from these applications may take various forms and may be stored in the memory of the user device or on an external server. Processing the data may include basic or advanced mathematical operations including addition, subtraction, multiplication, division, and various functions or operators. Processing can also include applying different algorithms or filters to collected data to smooth or refine the result. The above methods are examples and not intended to limit how data may be refined or processed by the system.

The request to output a report 610 may be initiated by the user or an external party or device. The request may be communicated via a user interface, from a device processor, or communicated from an external device via a connected network.

After receiving a request to generate a report, the system then generates one or more intention gap reports 612. This generation may comprise the processing of collected data into certain formats, or the displaying of collected data into predetermined graphical presentations. This processing may be performed on the user device, or may occur on an external device connected to a user device via a network.

The reports may be displayed to a user 614 via a user interface on the display of a user device or communicated via a network to an external device. These reports may take the form of various graphs or plots that contain collected metrics for one or more life domains. Results from the generated reports may be communicated to the device processor or externally to a server via a network 618. This communication may cause the device to change certain operating characteristics, or cause the external device to transmit updated operating instructions to the user device over the network.

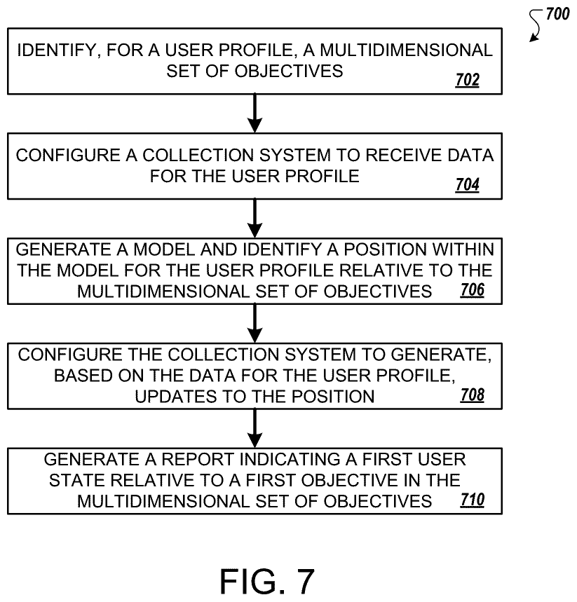

FIG. 7 is an example process 700 for an Intention Economy management system. The process includes identifying, for a user profile, a multidimensional set of objectives (702). The process 700 also includes configuring a collection system to receive data for the user profile (704). In some examples, the collection system receives data from at least one third-party service that collects user data. In some examples, a smart contract authorizes the third-party service to transmit user data to the collection system. The process 700 also includes generating a model and identifying a position within the model for the user profile relative to the multidimensional set of objectives (706). The process 700 also includes configuring the collection system to generate, based on the data for the user profile, updates to the position (708). In some examples, based at least in part on updates to the user position, the process transmits information that describes the change in user position to at least one third-party service. In some examples, updates to the position in the model also update the data stored on the blockchain distributed ledger. Finally, the process 700 includes generating, for at least a first dimension in the multidimensional set of objectives, a report indicating a first user state relative to a first objective in the multidimensional set of objectives (710).

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program which may also be referred to or described as a program, software, a software application, an app, a module, a software module, a script, or code) can be written in any form of programming language, including compiled or interpreted languages, or declarative or procedural languages, and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

As used in this specification, an “engine,” or “software engine,” refers to a software implemented input/output system that provides an output that is different from the input. An engine can be an encoded block of functionality, such as a library, a platform, a software development kit (“SDK”), or an object. Each engine can be implemented on any appropriate type of computing device, e.g., servers, mobile phones, tablet computers, notebook computers, music players, e-book readers, laptop or desktop computers, PDAs, smart phones, or other stationary or portable devices, that includes one or more processors and computer readable media. Additionally, two or more of the engines may be implemented on the same computing device, or on different computing devices.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential address of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and pointing device, e.g, a mouse, trackball, or a presence sensitive display or other surface by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone, running a messaging application, and receiving responsive messages from the user in return.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain cases, multitasking and parallel processing may be advantageous.

What is claimed is:

1. A method comprising:
identifying, for a user profile, a multidimensional set of objectives;
configuring a collection system to receive data for the user profile;
generating a model and identifying a position within the model for the user profile relative to the multidimensional set of objectives;
configuring the collection system to generate, based on the data for the user profile, updates to the position; and
generating, for at least a first dimension in the multidimensional set of objectives, a report indicating a first user state relative to a first objective in the multidimensional set of objectives.

2. The method of claim 1 further comprising:
generating a recommendation for the user profile to move the first user state closer to the objectives in the multidimensional set of objectives.

3. The method of claim 1, wherein the collection system receives data from at least one third-party service that collects user data.

4. The method of claim 3, wherein a smart contract authorizes the third-party service to transmit user data to the collection system.

5. The method of claim 1, wherein identifying a multidimensional set of objectives comprises receiving user input to a survey directed to life aspirations.

6. The method of claim 3, further comprising:
determining, by the data collection system and based on data received from the third-party service, that the position of the user profile within the model has changed; and,
updating the position of the user within the model.

7. The method of claim 1, further comprising:
based at least in part on updates to the user position, transmitting information that describes the change in user position to at least one third-party service.

8. The method of claim 1, further comprising:
storing data describing the user profile or model on a blockchain distributed ledger.

9. The method of claim 8, wherein updates to the position in the model also update the data stored on the blockchain distributed ledger.

10. The method of claim 8, further comprising:
transmitting model data from the blockchain distributed ledger using an Application Programming Interface configured to provision model data to at least one third-party service.

11. A method comprising:
identifying, for a user profile, a multidimensional set of objectives;
configuring a collection system to receive data for the user profile;
generating a model and identifying a position within the model for the user profile relative to the multidimensional set of objectives;
providing the model as a prompt to an analytical engine configured to make recommendations based on received prompts; and,
receiving at least one recommendation from the analytical engine based on the prompt.

12. The method of claim 11, wherein the analytical engine comprises an artificial intelligence service.

13. The method of claim 11, wherein the analytical engine comprises a machine learning algorithm trained on past recommendations.

14. The method of claim 11, further comprising:
based at least in part on the at least one recommendation, updating the multidimensional set of objectives.

15. The method of claim 11, further comprising:
receiving updated data, based at least in part on the at least one recommendation; and,
updating the position of the user within the model.

16. The method of claim 11, further comprising:
storing data describing the user profile or model on a blockchain distributed ledger.

17. A method comprising:
identifying, for a user profile, a multidimensional set of objectives;
configuring a collection system to receive data for the user profile;
generating a model and identifying a position within the model for the user profile relative to the multidimensional set of objectives;
storing the model on a blockchain distributed ledger;
receiving, from a third-party service, a request to access data corresponding to the model on the blockchain distributed ledger;
determining that the third-party service is authorized to access data corresponding to the model; and,
in response, transmitting data to the third-party service corresponding to the model.

18. The method of claim 17, wherein determining that the third-party service is authorized to access the data comprises determining that a smart contract allowing data access has been issued to the third party.

19. The method of claim 18, wherein the smart contract specifies a period within which the third-party service can access data from the model.

20. The method of claim 17, wherein the request to access data from the model is received from a third-party service Application Programming Interface configured to receive model data.
